(19) United States
(12) Patent Application Publication
(10) Pub. No.: US 2004/0059734 A1
(43) Pub. Date: Mar. 25, 2004

(54) Data access control

(76) Inventors: Hubbert Smith, Sandy, UT (US); Anurag Gupta, Seattle, WA (US); Keith L. Yedlin, Seattle, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/253,829

(22) Filed: Sep. 23, 2002

(51) Int. Cl. G06F 17/30; G06F 7/00

(52) U.S. Cl. 707/9

(57) ABSTRACT

In one embodiment, a method is provided. The method of this embodiment may include determining by circuitry at a first node, in response, at least in part, to a first message received at the first node, whether to grant a second node access to data accessible by a third node. This first message may include, at least in part, a request that the second node be granted the access to the data. If the circuitry determines to grant the access to the data, the method of this embodiment may also include generating at and issuing from the circuitry a second message indicating, at least in part, that the access has been granted to the second node, and modifying by the circuitry information accessible by the circuitry to indicate that the access has been granted to the second node.

### FIELD

This application relates to data access control.

### BACKGROUND

In one conventional distributed database system, a plurality of client computers are coupled to a plurality of server computers via a local area network (LAN). The system also includes database storage that may be accessible to the respective servers.

In this conventional system, a client computer may request access to data stored in the database storage by issuing an access request message that requests such access to a server computer. In response to the message, the server computer may examine access privilege and access lock information shared among the server computers to determine whether the client computer requesting access to the data in the database storage has been granted the privilege of being able to access the data, and whether the access to the data cannot be granted to the client computer because access to the data has been locked, e.g., in favor of another client computer that is currently granted an exclusive access to the data. Thus, in this conventional system, a portion of the server computers' processing resources may be used to examine the shared privilege and access lock information and to determine therefrom whether to grant permission to the client computers to access data in the database storage, and to manage locking of access to that data.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram illustrating a system embodiment.

FIG. 2 is a diagram illustrating construction of a database access management appliance according to an embodiment.

FIG. 3 is a flowchart illustrating operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

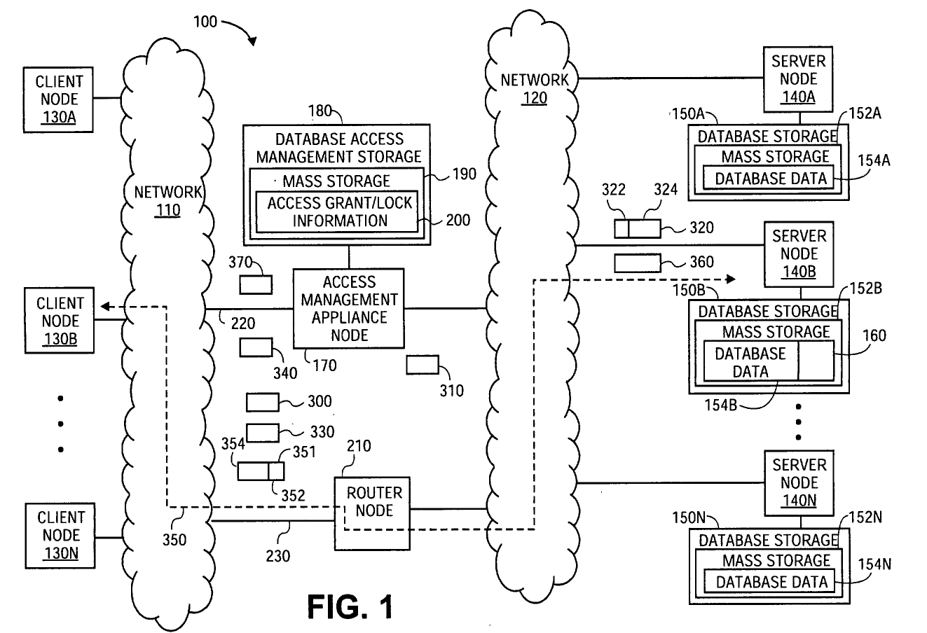

FIG. 1 is a diagram of a system embodiment 100. System 100 may include, e.g., a plurality of client computer nodes 130A, 130B, . . . 130N that are electrically coupled to a communications network 120. System 100 may also include, e.g., a plurality of server computer nodes 140A, 140B, . . . 140N that are electrically coupled to another communications network 120. Networks 110 and 120 may be electrically coupled together via network segments 220 and 230. Network segment 220 may comprise, e.g., an access management appliance computer node 170. Network segment 210 may comprise an internetwork router, such as, e.g., router node 210. Alternatively, without departing from this embodiment, instead of comprising router node 210, network segment 230 may comprise, e.g., a network switch node (not shown) or a network bridge node (also not shown).

The respective numbers of client nodes 130A, 130B, . . . 130N and server nodes 140A, 140B, . . . 140N shown in FIG. 1 are merely for purposes of illustration. Thus, the respective numbers of client nodes 130A, 130B, . . . 130N and server nodes 140A, 140B, . . . 140N in system 100 may vary without departing from this embodiment. Additionally, without departing from this embodiment, the number of client nodes 130A, 130B, . . . . 130N may be different from the number of server nodes 140A, 140B, . . . 140N in system 100.

Although not shown in the Figures, each of the client computer nodes 130A, 130B, . . . 130N, router computer node 210, and server computer nodes 140A, 140B, . . . 140N may comprise respective computer-readable memory for storing software programs and data structures, including respective network communication protocol programs and data structures, associated with, and for carrying out the operations and/or functions described herein as being carried out by nodes 130A, 130B, . . . 130N, node 210, and nodes 140A, 140B, . . . 140N. Additionally, each of nodes 130A, 130B, . . . 130N, node 210, and nodes 140A, 140B, . . . 140N may include respective processor and/or communication circuitry (e.g., respective network interface circuitry) that may execute such software programs and/or manipulate such data structures. The execution of such software programs and/or manipulation of such data structures by such respective processor and/or communication circuitry in nodes 130A, 130B, . . . 130N, node 210, and nodes 140A, 140B, . . . 140N may result in nodes 130A, 130B, . . . 130N, node 210, and nodes 140A, 140B, . . . 140N carrying out the operations and/or functions described herein as being carried out by nodes 130A, 130B, . . . 130N, node 210, and nodes 140A, 140B, . . . 140N

In this embodiment, each network 110 and 120 may comprise one or more respective local area and/or wide area networks that may utilize one or more well-known network communication protocols, such as, for example, Ethernet protocol, transmission control protocol/internet protocol (TCP/IP), and/or Fibre Channel (FC) protocol. For example, network 110 may comprise a LAN that may electrically couple together client nodes 130A, 130B, . . . 130N, and network 120 may comprise a LAN that may electrically couple together server nodes 140A, 140B, . . . 140N. This may permit client nodes 130A, 130B, . . . 130N and server nodes 140A, 140B, . . . 140N to exchange packets and/or frames, in compliance or compatible with one or more such protocols, among each other. These packets and/or frames may comprise messages that may include commands and/or data.

If an Ethernet protocol is utilized in network 110 and/or network 120, it may be compliant or compatible with the protocol described in Institute of Electrical and Electronics Engineers, Inc. (IEEE) Std. 802.3, 2000 Edition, published on Oct. 20, 2000. If TCP/IP is utilized in network 110 and/or network 120, it may be compliant or compatible with the protocols described in Internet Engineering Task Force (IETF) Request For Comments (RFC) 791 and 793, published September 1981. If FC protocol is utilized in network 110 and/or network 120, it may be compliant or compatible with the protocol described in ANSI Standard Fibre Channel (FC) Physical and Signaling Interface-3 X3.303:1998 Specification. Of course, other network communication protocols may be utilized in network 110 and/or network 120 without departing from this embodiment.

Each server computer node 140A, 140B, . . . 140N may be associated with, electrically coupled to, and control the respective operation of respective database storage 150A, 150B, . . . . 150N. Each database storage 150A, 150B, . . . 150N may include respective mass storage 152A, 152B, . . . 152N. Each mass storage 152A, 152B, and 152N may comprise, e.g., a respective set of one or more magnetic disk, optical disk, solid-state, and/or semiconductor mass storage devices (not shown) comprising, for example, a respective (not shown) redundant array of inexpensive disks (RAID). Server computer nodes 140A, 140B, . . . 140N may exchange data and/or commands with database storage 150A, 150B, . . . 150N, respectively, that may result in mass storage 152A, 152B, and 152N storing database data 154A, 154B, . . . 154N, respectively, and/or server nodes 140A, 140B, . . . 140N accessing database storage 150A, 150B, . . . 150N, respectively, to access database data 154A, 154B, . . . 154N, respectively.

Access management appliance node 170 may be associated with, coupled to, and control the operation of database access management storage 180. Storage 180 may include mass storage 190. Mass storage 190 may include, e.g., a set of one or more magnetic disk, optical disk, solid-state, and/or semiconductor mass storage devices (not shown) comprising, for example, a redundant array of inexpensive disks (RAID). Appliance node 170 may exchange data and/or commands with storage 180 that may result in mass storage 190 storing access grant and/or lock information 200, and/or node 170 accessing storage 180 to access information 200.

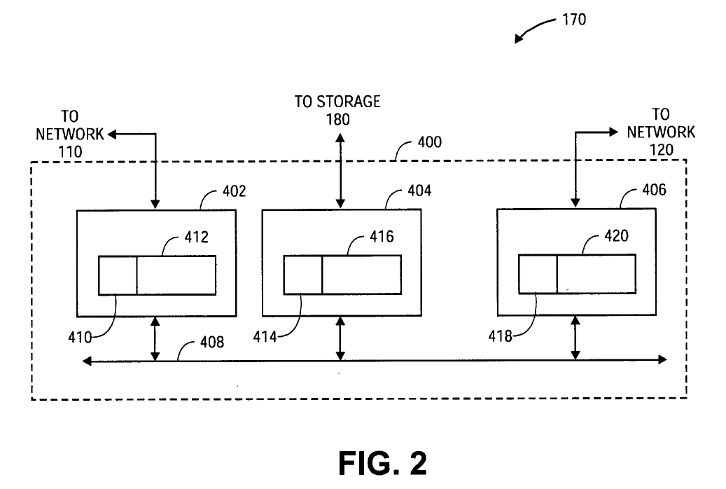

FIG. 2 is a diagram illustrating construction of database access management appliance node 170 according to an embodiment. As shown in FIG. 2, appliance node 170 may include operative circuitry 400. Circuitry 400 may include operative circuitry, such as, for example, circuit cards 402, 404, and 406. Cards 402, 404, and 406 may be electrically coupled (via, for example, not shown respective bus extension slots) to bus 408. A “bus” as referred to herein means circuitry to transmit data between or among two or more devices; such circuitry may, for example, comprise one or more communications media through which one or more signals may be propagated between such devices.

Card 402 may include operative circuitry that may include an I/O processor 410 and computer-readable memory 412. In this embodiment, this operative circuitry in card 402 may be electrically coupled to network 110.

Card 404 may include operative circuitry that may include an I/O processor 414 and computer-readable memory 416. In this embodiment, this operative circuitry in card 404 may be electrically coupled to storage 180.

Card 406 may include operative circuitry that may include an I/O processor 418 and computer-readable memory 420. In this embodiment, this operative circuitry in card 406 may be electrically coupled to network 120.

Bus 408 may comprise a bus system that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, bus 408 instead may comprise a bus system that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also alternatively, bus 408 may comprise other types and configurations of bus systems, without departing from this embodiment. Bus 408 may be comprised in, e.g., a computer motherboard (not shown) that may comprise the bus extension slots that may be used to couple the respective operative circuitry of cards 402, 404, and 406 to bus 408. For example, cards 402, 404, and 406 may be constructed to be inserted into these bus extension slots; when cards 402, 404, and 406 are so inserted into these bus extension slots, the respective operative circuitry of cards 402, 404, and 406 may become electrically coupled to bus 408.

Depending upon the particular embodiment, computer-readable memories 412, 416, and 420 each may comprise one or more of the following types of computer-readable memories: semiconductor firmware memory, programmable memory, non-volatile memory, read only memory, electrically programmable memory, random access memory, cache memory, flash memory, magnetic disk memory, and/or optical disk memory. Additionally, it should be appreciated that, either additionally or alternatively, computer-readable memories 412, 416, and 420 each may comprise other and/or later-developed types of computer-readable memory. Processors 410, 414, and 418 each may include integrated circuit chips (not shown) comprised in an integrated circuit chipset, such as those commercially available from the Assignee of the subject application (e.g., the Intel® 80310 Chipset). Alternatively, processors 410, 414, and 418 each may comprise other integrated circuit chips (e.g., the Intel® 80960 RM/RN I/O processor, the Intel® 80321 processor, and/or other types of processors that are available from sources other than the Assignee of the subject application), or other types of processors/integrated circuits without departing from this embodiment of the claimed subject matter.

Of course, the respective operative circuitry in cards 402, 404, and 406 need not be comprised in cards 402, 404, and 406. Instead, without departing from this embodiment, may be comprised in other structures, systems, and/or devices that may be coupled to bus 408, and exchange data and/or commands with other components of system 100, in the manner described herein. Alternatively, the respective operative circuitry in cards 402, 404, and 406 may be comprised in a single circuit card (not shown) that may be coupled to bus 408.

Additionally, the respective operative circuitry of cards 402, 404, and 406 may not be limited to the respective operative circuitry previously described herein as being comprised in cards 402, 404, and 406. Instead, the respective operative circuitry of cards 402, 404, and 406 may include other additional and/or alternative circuitry that may permit and/or facilitate execution by cards 402, 404, and 406 of the operations described herein as being executed by cards 402, 404, and 406, and/or additional and/or other operations, without departing from this embodiment.

Although not shown in the Figures, without departing from this embodiment, operative circuitry 400 may also include, for example, a host bridge/hub system that may couple a host processor, a system memory, and a user interface system to each other and to bus 408. Appliance node 170 may also an I/O bridge/hub system (not shown) that may couple the host bridge/bus system to bus 408. The host processor may comprise, for example, an Intel® Pentium® III or IV microprocessor that is commercially available from the Assignee of the subject application. Of course, alternatively, host processor 12 may comprise another type of microprocessor. The user interface system may comprise, e.g., a keyboard, pointing device, and display system that may permit a human user to input commands to, and monitor the operation of appliance node 170.

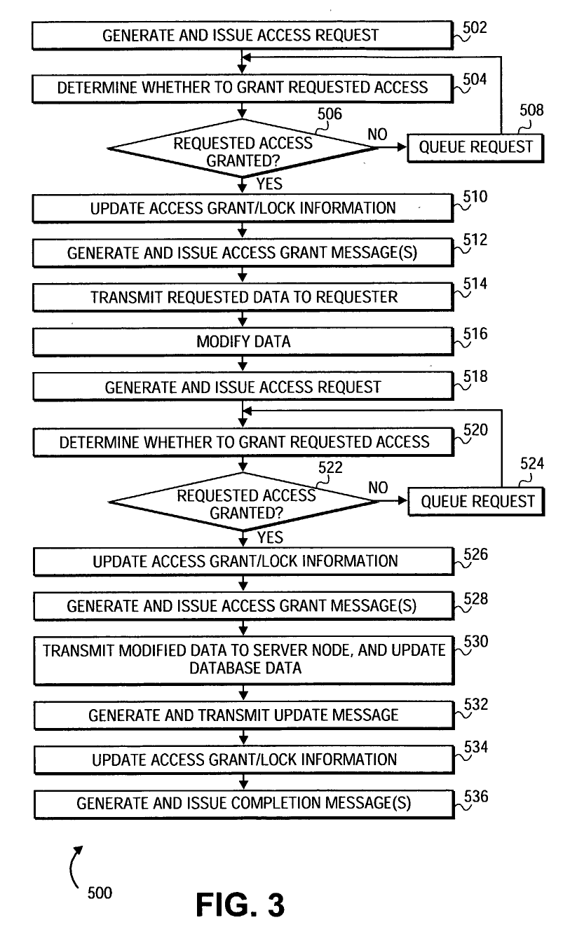

Respective sets of machine-readable program instructions may be stored in computer-readable memories 412, 416, and 420. These sets of instructions may be accessed and executed by processors 410, 414, and 418, respectively. When executed by processors 410, 414, and 418, these respective sets of instructions may result in processors 410, 414, and 418 performing the operations described herein as being performed by processors 410, 414, and 418, respectively. These and other operations 500 that may be carried in system 100, in accordance with one embodiment, will now be described with reference to FIG. 3.

More specifically, in system 100, when a human user of one of the client nodes 130A, 130B, . . . 130N (e.g., client node 130B) wishes to access a portion (e.g., portion 160) of database data 154B stored in database storage 150B, the user may issue to that client node 130B via, for example, a not shown user interface, a command to access that portion 160 of database data 154B. As used herein, “accessing” data may comprise reading, writing, updating, and/or modifying the data. In response to this command, client node 130B may generate and issue to appliance node 170 an access request message 300, as illustrated by operation 502 in FIG. 3. As used herein, a “message” means a sequence of data values used to convey information, and may comprise, for example, one or more frames, packets, and/or datagrams in accordance with, for example, one or more communication protocols described previously. Message 300 may comprise and/or indicate a request from client node 130B that client node 130B be granted by appliance node 170 access to portion 160 of database data 154B. More specifically, message 300 may comprise and/or indicate one or more values may identify and/or specify information, such as, for example, the human user of client node 130B, client node 130B, portion 160 of database data 154B to which access is being requested, the type(s) of access to portion 160 being requested (e.g., read-shared, read-exclusive, update/modify, write-exclusive, write-shared, and/or delete access, etc.), data access lock(s) requested to maintain coherency of portion 160, and/or a time-out period after which any requested grant of access to and/or lock of access to portion 160 is to expire and/or not remain valid. Hereinafter, the information that may be identified and/or specified by these one or more values that may be comprised and/or indicated in message 300 is termed “request message information.”

Portion 160 may be identified and/or specified in message 300 in terms of, e.g., one or more values that may identify and/or specify one or more corresponding records in database data 154B and/or one or more address ranges in database storage 150B and/or mass storage 152B. Examples of types of data access locks that may be requested in message 300 may include, for example, depending upon the type of database data comprised in portion 160, one or more of the following types of data access locks: row level lock, page level lock, table level lock, shared access lock, exclusive access lock, and currently-shared-with-intent-to-change-to-exclusive access lock.

After being issued from client node 130B, message 300 may be transmitted through network 110 to segment 220, and thence, to appliance node 170. The operative circuitry of card 402 in appliance 170 may receive message 300 from network 110. In response, at least in part, to receipt of message 300 by the operative circuitry in card 402, the operative circuitry in card 402 may signal processor 410. This may result in processor 402 signaling processor 414 via bus 408. This may result in processor 414 determining whether to grant the request comprised in message 300 (i.e., the request that client node 130B be granted by appliance node 170 access to portion 160 of database data 154B), as illustrated by operation 504 in FIG. 3.

For example, as a result of operation 504, processor 414 may examine message 300 and may determine therefrom the request information that may be comprised, specified, and/or identified therein. Based at least in part upon this request information and access grant and lock information 200, processor 414 may determine whether to grant to client node 130B the access to portion 160 requested by the request information. Also, based at least in part upon this request information and access grant and lock information 200, processor 414 may determine whether to grant to client node 130B any data access lock requested in such request information.

That is, access grant and lock information 200 may comprise data that may correlate, for example, clients nodes 130A, 130B, . . . 130N and/or human users of clients nodes 130A, 130B, . . . 130N with access privileges for respective portions of database data 154A, 154B, . . . 154N. These access privileges may indicate and/or specify, for example, the types of accesses (e.g., read-shared, read-exclusive, update/modify, write-exclusive, write-shared, and/or delete access, etc.) to respective portions of database data 154A, 154B, . . . 154N, such as, for example, portion 160 of database data 154B, that respective client nodes 130A, 130B, . . . 130N and/or respective human users of client nodes 130A, 130B, . . . 130N may be permitted to be granted by appliance node 170. Access grant and lock information 200 also may comprise data that may correlate, for example, currently granted data accesses and data access locks with respective portions (e.g., one or more records) of database data 154A, 154B, . . . 154N that may be subject to such currently granted data accesses and data access locks, and respective time-out periods after which such currently granted data accesses and data access locks may expire and/or not remain valid. Information 200 also may correlate the currently granted data accesses and/or data access locks with the respective client nodes 130A, 130B, . . . 130N and/or human users that may be currently granted such data accesses and/or data access locks, and the types of such currently granted data accesses and/or data access locks. Information 200 may also correlate these respective portions of database data 154A, 154B, . . . 154N with respective database storage 150A, 150B, . . . 150N and/or mass storage 152A, 152B, . . . 152N addresses and/or database data records that may comprise these respective portions of database data 154A, 154B, . . . 154N. In information 200, these respective portions of database data 154A, 154B, . . . 154N may also be correlated with the respective server node 140A, 104B, . . . 140N that may be associated with the respective database storage 150A, 150B, . . . 150N that may comprise these respective portions.

For example, information 200 may comprise a hash table (not shown). This hash table may comprise an array of pointers that may point to respective head nodes of respective doubly-linked lists. Each node in these doubly-linked lists may represent a respective portion (e.g., comprising one or more records) of database data 154A, 154B, . . . 154N to which at least one client nodes 130A, 130B, . . . 130N and/or at least one human user is currently granted access and/or that is subject to a current data access lock. Each such node in these doubly-linked lists may be associated with, and may be included in a given one of the linked lists 130A, 130B, . . . 130N based upon and/or in accordance with a conventional hashing function that may map, to indices into the array of pointers, one or more values that may identify these respective portions of database data 154A, 154B, . . . 154N in terms of one or more corresponding database records and/or one or more address ranges in database storage 150A, 150B, . . . 150N and/or mass storage 152A, 152B, . . . 152N. Each respective node in these doubly-linked lists also may include, for example, one or more respective values that may indicate and/or specify the respective the respective portion of database data 154A, 154B, . . . 154N represented by the respective node, the type(s) of data access(es) and/or access lock(s) to which the respective portion of database data 154A, 154B, . . . 154N is currently subject, and the client node(s) in system 100 granted such access(es) and/or in whose favor such lock(s) have been granted. Additionally, the one or more respective values in each respective node in these doubly-linked lists may indicate and/or specify, for example, respective time-out periods after which such currently granted data access(es) and/or data access lock(s) may expire and/or not remain valid, and the respective times at which such currently granted data access(es) and/or data access lock(s) may have been granted and/or the request message requesting their grant may have been received by appliance node 170.

Processor 414 may determine from the request information from message 300 the one or more values that may identify and/or specify the client node 130B issuing message 300, the human user of that client node 130B, respective portion 160 of database data 154B that client node 130B is requesting to access, the types of access and access lock being requested by client node 130B. Processor 414 then may compare the database data access privileges, if any, as indicated in information 200, of client node 130B and/or the human user of client node 130B to determine whether client node 130B and the human user of client node 130B have sufficient privileges to be granted the types of access and access lock requested in message 300. If processor 414 determines that client node 130B and/or the human user of client node 130B do not have sufficient privileges to be granted the types of access and access lock requested in message 300, processor 414 may determine not to grant the access and access lock requested in message 300, and processor 414 may signal processor 410. This may result in the operative circuitry of card 402 generating and issuing to client node 130B, via network 110, an access reply message (not shown) that may indicate that client node 130B and/or the human user of client node 130B have not been granted the access and access lock requested in message 300 because client node 130B and/or the human user lack sufficient privileges to granted same.

Conversely, if processor 414 determines that client node 130B and the human user of client node 130B have sufficient privileges to be granted the access and access lock requested in message 300, processor 414 may utilize a conventional hashing operation to generate, based at least in part upon the one or more values in message 300 that may identify portion 160, an index into the hash table in information 200. Processor 414 may locate a linked-list in the hash table that may be associated with that index, and may examine that linked-list to determine whether a node exists in the linked-list that represents portion 160.

If such a node exists, processor 414 may examine the contents of that node to determine the type(s) of data access(es) that may be currently granted to portion 160, and/or the type(s) of access lock(s) to which portion 160 may be currently subject. Processor 414 then may compare the respective type(s) of data access(es) that may be currently granted to portion 160, and/or the type(s) of access lock(s) to which portion 160 may be currently subject, with the types of data access and access lock requested in message 300, to determine whether the types of data access and access lock requested in message 300 may conflict with any of the respective type(s) of data access(es) that may be currently granted to portion 160, and/or the type(s) of access lock(s) to which portion 160 may be currently subject. If processor 414 determines that such a conflict exists, processor 414 may not grant, at least temporarily, the data access and access lock requested in message 300, as illustrated by operation 506 in FIG. 3. Thereafter, processor 414 may queue, for possible future grant (e.g., after expiration of any currently granted access(es) and access lock(s) that may conflict with the data access and lock requests in message 300), the data access and access lock requests indicated in message 300, as illustrated by operation 508. For example, after expiration of a previously granted access or access lock, processor 414 may signal storage 180. This may result in storage 180 updating the hash table in information 200 to delete reference to the expired granted of access or access lock, and after such updating, if no access or access lock is indicated in a given node in the hash table as being currently granted with respect to the portion of database data represented by that node, storage 180 may delete that node from the hash table. After expiration of any currently granted access(es) and access lock(s) that may conflict with the data access and access lock requested in message 300, operation 504 may again be performed to determine whether to grant the data access and access lock requested in message 300.

If, as a result of operation 504, processor 414 determines either that no node representing portion 160 exists in the hash table, or that no currently granted access(es) and access lock(s) indicated in the hash table may conflict with the data access and lock request in message 300, processor 414 may grant, as a result of operation 506, the data access and lock request in message 300. This may result in processor 414 signaling storage 180. This may result in storage 180 updating information 200 to reflect the grant by appliance node 170 of the data access and access lock requested in message 300, as illustrated by operation 510 in FIG. 3. For example, if as a result of operation 504, processor 414 determines that no node representing portion 160 exists in the hash table, processor 414 may signal storage 180. This may result in storage 180 including in the hash table a node representing portion 160 that includes information that indicates that client node 130B and/or the human user of client node 130B have been granted the type of access requested in message 300, portion 160 has become subject to the access lock requested in message 300, and the time of grant and expiration (if any) of this access and access lock. Also, for example, if, as a result of operation 504, processor 414 determines that a node representing portion 160 exists in the hash table, but no currently granted access(es) and access lock(s) indicated in that node may conflict with the data access and lock requests in message 300, processor 414 may signal storage 180. This may result in storage 180 including in the existing node representing portion 160 in hash table information that indicates that client node 130B and/or the human user of client node 130B have been granted the type of access requested in message 300, portion 160 has become subject to the access lock requested in message 300, and the time of grant and expiration (if any) of this access and access lock.

Thereafter, processor 414 may signal processor 418. This may result in processor 418 signaling the operative circuitry in card 406. This may result in the operative circuitry in card 406 generating and issuing to server node 140B associated with database storage 150B that comprises portion 160 of database data 154B, via network 120, an access grant message, as illustrated by operation 512 in FIG. 3. Alternatively, as part of operation 512, in addition to issuing to server node 140B access grant message 310, the operative circuitry in card 402 may also issue to client node 130B, via network 110, a respective access grant message 310. Access grant message 310 may comprise and/or specify a token that may specify and/or indicate one or more values that may specify and/or identify, e.g., portion 160, the types of access and access lock granted with respect to portion 160 as a result of operation 506, client node 130B, server node 140B, and times of grant and expiration (if any) of the access and access lock.

In response, at least in part, to receipt by server node 140B of access grant message 310, server node 140B may signal database storage 150B. This may result in database storage 150B transmitting to server node 140B portion 160 of database data 154B. After server node 140B receives portion 160 of database data 154B, server node 140B may generate and transmit to client node 130B, via network 120, network segment 230, and network 110, one or more messages (collectively and/or singly referred to herein as “message 320”) that may comprise portion 160, as illustrated by operation 514 in FIG. 3. For example, message 320 may include header 322 and data payload 324. Payload 324 may include, e.g., a copy of portion 160. Alternatively, or additionally, payload 324 may include, e.g., an acknowledgement indicating that portion 160 was written. Header 322 may include network routing information that may specify and/or indicate a path 350 via which message 320 is to be propagated, forwarded, and/or routed from server node 140B to client node 130B. For example, in this embodiment, path 350 may pass through network 120, network segment 230, and network 110; however, path 350 may by-pass (i.e., exclude) segment 220. This may result in message 320 being routed from server node 140B to client node 130B via network route 350 which bypasses network segment 220 that comprises appliance node 170. After client node 130B receives the message 320, client node 130B may store the copy of portion 160 of database data 154B comprised in message 320. Client node 130B previously may have retained and/or stored in client node 130B the token that was comprised and/or specified in access grant message 310; this may permit client node 130B to retain the access privileges, etc. that may have been specified and/or indicated by the token. This may permit, for example, the human user of client node 130B to be able to review and/or modify the copy of portion 160 stored in client node 130B.

Thereafter, client node 130B may modify the copy of portion 160 of database data 154B stored in client node 130B, as illustrated by operation 516 in FIG. 1. For example, the human user of client node 130B may issue one or more commands to client node 130B via the not shown user interface that may result in client node 130B modifying the copy of portion 160 in client node 130B. Thereafter, in order to initiate an updating of portion 160 of database data 154B stored in storage 150B to reflect the modification made to the copy of portion 160 in client node 130B (e.g., so as to modify portion 160 stored in storage 150B so as to be identical to the copy of portion 160 stored in client node 130B), client node 130B may generate and issue to appliance node 170, via network 110, an additional access request message 330, as illustrated by operation 518 in FIG. 1. Message 330 may contain request message information of the type(s), described previously, that may be comprised in message 300. The request message information in message 330 may request, e.g., that client node 130B be granted access to portion 160 of database 154B in database storage 150B for the purpose of writing to portion 160 in storage 150B, and that an exclusive data modification access lock be imposed on portion 160 in storage 150B granting client node 130B exclusive access to portion 160 in storage 150B until client node 130B has finished writing to portion 160 in storage 150B. This requested access lock, if imposed by appliance node 170, may prevent any client node in system 100, except client node 130B, from being granted any access to portion 160 in storage 150B except for the purpose of reading portion 160 in storage 150B.

After being issued from client node 130B, message 330 may be transmitted through network 110 to segment 220, and thence, to appliance node 170. The operative circuitry of card 402 in appliance 170 may receive message 330 from network 110. In response, at least in part, to receipt of message 330 by the operative circuitry in card 402, the operative circuitry in card 402 may signal processor 410. This may result in processor 402 signaling processor 414 via bus 408. This may result in processor 414 determining whether to grant the data access and access lock request comprised in message 330 (e.g., that client node 130B be granted access to portion 160 of database 154B in database storage 150B for the purpose of writing to portion 160 in storage 150B, and that an exclusive access lock be imposed on portion 160 in storage 150B granting client node 130B exclusive access to portion 160 in storage 150B until client node 130B has finished writing to portion 160 in storage 150B), as illustrated by operation 520 in FIG. 3. The manner in which operation 520 may be implemented in system 100 may be, for example, substantially identical to the manner in which operation 504 may be implemented in system 100.

If, as a result of operation 520, processor 414 determines not to grant the data access and access lock request comprised in message 330, processor 414 may not grant, at least temporarily, as illustrated by operation 522, the data access and access lock request comprised in message 330. Thereafter, processor 414 may queue, for possible future grant (e.g., after expiration of any currently granted access(es) and access lock(s) that may conflict with the data access and lock request in message 330), the data access and access lock request indicated in message 330, as illustrated by operation 524. The manner in which operation 522 may be implemented in system 100, may be, for example, substantially identical to the manner in which operation 506 may be implement in system 100. Additionally, the manner in which operation 524 may be implemented in system 100, may be, for example, substantially identical to the manner in which operation 508 may be implemented in system 100.

Conversely, if, as a result of operation 520, processor 414 determines to grant the data access and access lock request comprised in message 330, processor 414 may grant, as illustrated by operation 522, the data access and access lock request comprised in message 330. This may result in processor 414 signaling storage 180. This may result in storage 180 updating information 200 to reflect the grant by appliance node 170 of the data access and access lock requested in message 330, as illustrated by operation 526 in FIG. 3. The manner in which operation 526 may be implemented in system 100 may be substantially identical to the manner in which operation 510 may be implemented in system 100.

Thereafter, processor 414 may signal processor 410. This may result in processor 410 signaling the operative circuitry in card 402. This may result in the operative circuitry in card 402 generating and issuing to client node 130B, via network 110, another access grant message 340, as illustrated by operation 528 in FIG. 3. Alternatively, as part of operation 528, in addition to issuing to client node 130B the other access grant message 340, the operative circuitry in card 406 may also issue to server node 140B, via network 120, a respective access grant message 340. Access grant message 340 may comprise and/or specify one or more values that may specify and/or identify, e.g., portion 160, the types of access and access lock granted with respect to portion 160 as a result of operation 522, server node 140B, client node 130B, and times of grant and expiration (if any) of the granted access and access lock.

In response, at least in part, to receipt by client node 130B of access grant message 340, client node 130B may generate and transmit to server node 140B one or more messages (collectively and/or singly referred to herein as “message 351”) that may comprise the copy of portion 160, as modified by client node 130B, as illustrated by operation 530 in FIG. 3. For example, message 351 may include header 354 and data payload 352. Payload 352 may include, e.g., the copy of portion 160, as modified by client node 130B. Header 354 may include network routing information that may specify and/or indicate path 350 via which message 351 is to be propagated, forwarded, and/or routed from client node 130B to server node 140B. As stated previously, in this embodiment, path 350 may pass through network 120, network segment 230, and network 110; however, path 350 may by-pass (i.e., exclude) segment 220. This may result in message 351 being routed from client node 130B to server node 140B via network route 350 which by-passes network segment 220 that comprises appliance node 170. In response, at least in part, to receipt of message 351 by server node 140B, server node 140B may signal database storage 150B. This may result in storage 150B overwriting portion 160 of database data 154B with the copy of portion 160 that was modified by client node 130B. This may result in the updating of portion 160 of database data 154B to reflect the modification made by client node 130B to the copy of portion 160 that was stored in client node 130B, as is also illustrated by operation 530 in FIG. 3.

Thereafter, server node 140B may generate and transmit to appliance node 170, via network 120, an update message 360, as illustrated by operation 532 in FIG. 3. Message 360 may comprise one or more values that may indicate and/or specify that portion 160 in database storage 150B has been updated in accordance with the access request comprised in message 330, and accordingly, the access and access lock granted as a result of operation 522 may be revoked. After being issued from server node 140B, message 360 may be transmitted through network 120 to segment 220, and thence, to appliance node 170. The operative circuitry of card 406 in appliance 170 may receive message 360 from network 120. In response, at least in part, to receipt of message 360 by the operative circuitry in card 406, the operative circuitry in card 406 may signal processor 418. This may result in processor 418 signaling processor 414 via bus 408. This may result in processor 414 signaling storage 180. This may result in storage 180 updating information 200 to delete from information 200 indications of the access and access locks granted as a result of operations 506 and 522, as illustrated by operation 534. For example, as a result of operation 534, storage 180 may update the hash table in information 200 to delete reference to the access or access lock granted as a result of operations 506 and 522, and thereafter, if the node representing portion 160 in the hash table contains no indication that any there is any current grant of access or of an access lock with respect to portion 160, storage 180 may delete that node from the hash table.

Thereafter, processor 414 may signal processor 410. This may result in processor 414 signaling the operative circuitry in card 402. This may result in the operative circuitry of card 402 generating and issuing to client node 130B, via network 110, a transaction completion message 370, as illustrated by operation 536 in FIG. 3. Alternatively, in addition to issuing message 370 to client node 130B, the operative circuitry in card 406 may issue a respective transaction completion message 370 to server node 140B. This may indicate the end of operations 500.

Thus, in summary, in one system embodiment, a first node may comprise circuitry that is coupled to at least one client node and to at least one server node. The circuitry may be capable of determining, in response, at least in part, to a first message received by the circuitry, whether to grant the least one client node access to data accessible by the at least one server node. The first message may comprise, at least in part, a request that the at least one client node be granted the access to the data. In this system embodiment, if the circuitry determines to grant the access to the data, the circuitry may also be capable of generating and issuing a second message indicating, at least in part, that the access has been granted to the at least one client node. The circuitry may also be capable of modifying information accessible by the circuitry to indicate that the access has been granted to the at least one client node. Advantageously, in accordance with this system embodiment, no portion of the server node's processing resources may be used to determine whether to grant permission to the client node to access the data and/or to update and/or manage that information that indicates that such access has been granted to the client node.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. For example, the types of access locks that may be available for grant by appliance node 170 may include, e.g., “read-shared,” “write-shared,” “readexclusive,” “write-exclusive,” “update/modify,” and/or “delete” types of access locks. The grant of a read-shared type of access lock with respect to a respective portion of database data may signify that one or more client nodes, in whose favor the lock has been granted, may read, but not modify or delete the respective portion of data. The grant of a write-shared type of access lock with respect to a respective portion of database data may signify that one or more client nodes, in whose favor the lock has been granted, may write to the respective portion of data. The grant of a read-exclusive type of access lock with respect to a respective portion of database data may signify that only a single client node, in whose favor the lock has been granted, may read the respective portion of data. The grant of a write-exclusive type of access lock with respect to a respective portion of database data may signify that only a single client node, in whose favor the lock has been granted, may write to the respective portion of data. The grant of an update/modify or delete type of access lock with respect to a respective portion of database data may signify that a single client node, in whose favor the lock has been granted, may update or modify, or delete, respectively, the data. However, the types of access locks that may be available for grant by appliance node 170 may vary from the foregoing types of access locks without departing from this embodiment.

Also, for example, although not shown in the Figures, system 100 may include a primary appliance node 170 and a not shown, redundant appliance node having a construction that is identical to node 170. The redundant appliance node may utilize conventional failure detection and/or fault tolerance techniques to determine if primary node 170 is no longer operating as expected. If the redundant appliance node determines that the primary node 170 is no longer operating as expected, the redundant appliance node may utilize conventional failover techniques to assume the operations that were previously performed in system 100 by primary node 170.

Other modifications are also possible. Accordingly, it is intended that the claims be construed as covering all such modifications.

What is claimed is:

1. A method comprising:
determining by circuitry at a first node, in response, at least in part, to a first message received at the first node, whether to grant a second node access to data accessible by a third node, the first message comprising, at least in part, a request that the second node be granted the access to the data; and
if the circuitry determines to grant the access to the data:
generating at and issuing from the circuitry a second message indicating, at least in part, that the access has been granted to the second node; and
modifying by the circuitry information accessible by the circuitry to indicate that the access has been granted to the second node.

2. The method of claim 1, further comprising:
determining by the circuitry whether the access is currently granted; and
if the circuitry determines that the access is currently granted, queuing at the circuitry the request until the circuitry determines to grant the request.

3. The method of claim 2, wherein:
the determining by the circuitry whether the access is currently granted is based at least in part upon the information.

4. The method of claim 1, wherein:
the access requested by the request comprises at least one of a read of and a modification of the data.

5. The method of claim 1, wherein:
the access requested by the request comprises modification of the data; and
the method further comprises also modifying by the circuitry the information to indicate that the access has been exclusively granted to the second node.

6. The method of claim 1, wherein:
the second message is issued to the third node; and
in response, at least in part, to the second message, the third node issues the data to the second node via a network route that by-passes at least one network segment that includes the first node.

7. The method of claim 1, wherein:
the second message is issued to the second node; and
in response, at least in part, to the second message, the second node issues a modified version of the data to the third node via a network route that by-passes at least one network segment that includes the first node.

8. The method of claim 1, wherein:
the information includes lock information that indicates whether the access to the data has been locked; and
the circuitry determines whether to grant the access based, at least in part, upon the lock information.

9. An apparatus comprising:
circuitry at a first node, the circuitry being capable of determining, in response, at least in part, to a first message received by the circuitry, whether to grant a second node access to data accessible by a third node, the first message comprising, at least in part, a request that the second node be granted the access to the data; and
if the circuitry determines to grant the access to the data, the circuitry also being capable of:
generating at and issuing a second message indicating, at least in part, that the access has been granted to the second node; and
modifying information accessible by the circuitry to indicate that the access has been granted to the second node.

10. The apparatus of claim 9, wherein:
the circuitry is also capable of determining whether the access is currently granted; and
if the first node determines that the access is currently granted, the circuitry is capable of queuing the request until the circuitry determines to grant the request.

11. The apparatus of claim 10, wherein:
the circuitry is capable of determining whether the access is currently granted based at least in part upon the information.

12. The apparatus of claim 9, wherein:
the access requested by the request comprises at least one of a read of and a modification of the data.

13. The apparatus of claim 9, wherein:
the access requested by the request comprises modification of the data; and
the circuitry is also capable of modifying the information to indicate that the access has been exclusively granted to the second node.

14. The apparatus of claim 9, wherein:
the second message is issued to the third node; and
in response, at least in part, to the second message, the third node issues the data to the second node via a network route that by-passes at least one network segment that includes the first node.

15. The apparatus of claim 9, wherein:
the second message is issued to the second node; and
in response, at least in part, to the second message, the second node issues a modified version of the data to the third node via a network route that by-passes at least one network segment that includes the first node.

16. The apparatus of claim 9, wherein:
the information includes lock information that indicates whether the access to the data has been locked; and
the circuitry is capable of determining whether to grant the access based, at least in part, upon the lock information.

17. An article comprising:
a storage medium having stored thereon instructions that when executed by a machine result in the following:
determining by circuitry at a first node, in response, at least in part, to a first message received at the first node, whether to grant a second node access to data accessible via a third node, the first message comprising, at least in part, a request that the second node be granted the access to the data; and
if the circuitry determines to grant the access to the data:
generating at and issuing from the circuitry a second message indicating, at least in part, that the access has been granted to the second node; and
modifying by the circuitry information accessible by the circuitry to indicate that the access has been granted to the second node.

18. The article of claim 17, wherein the instructions when executed also result in:
determining by the circuitry whether the access is currently granted; and
if the circuitry determines that the access is currently granted, queuing in the circuitry the request until the circuitry determines to grant the request.

19. The article of claim 18, wherein:
the determining by the circuitry whether the access is currently granted is based at least in part upon the information.

20. The article of claim 17, wherein:
the access requested by the request comprises at least one of a read of and a modification of the data.

21. The article of claim 17, wherein:
the access requested by the request comprises modification of the data; and
the instructions when executed by the machine also result in modifying by the circuitry of the information to indicate that the access has been exclusively granted to the second node.

22. The article of claim 17, wherein:
the second message is issued to the third node; and
in response, at least in part, to the second message, the third node issues the data to the second node via a network route that by-passes at least one network segment that includes the first node.

23. The article of claim 17, wherein:
the second message is issued to the second node; and
in response, at least in part, to the second message, the second node issues a modified version of the data to the third node via a network route that by-passes at least one network segment that includes the first node.

24. The article of claim 17, wherein:
the information includes lock information that indicates whether the access to the data has been locked; and
the circuitry determines whether to grant the access based, at least in part, upon the lock information.

25. A system comprising:
circuitry at a first node, the circuitry being coupled to at least one client node and to at least one server node, the circuitry being capable of determining, in response, at least in part, to a first message received by the circuitry, whether to grant the least one client node access to data accessible by the at least one server node, the first message comprising, at least in part, a request that the at least one client node be granted the access to the data; and
if the circuitry determines to grant the access to the data, the circuitry also being capable of:
generating at and issuing a second message indicating, at least in part, that the access has been granted to the at least one client node; and
modifying information accessible by the circuitry to indicate that the access has been granted to the at least one client node.

26. The system of claim 25, wherein:
database storage accessible by the at least one server node comprises the data; and
the system further comprises a first network coupled to the at least one client node and a second network coupled to the at least one server node.

27. The system of claim 26, further comprising:
a first network segment coupling the first network to the second network;
the first network segment comprises the circuitry; and
the circuitry comprises a first processor coupled to the first network and a second processor coupled to the second network.

28. The system of claim 27, wherein:
the processors comprise respective input/output (I/O) processors.

29. The system of claim 27, wherein:
each of the server nodes is associated with respective database storage.

30. The system of claim 25, wherein:
the circuitry comprises a first processor coupled to a first network, a second processor coupled to a second network, and a third processor coupled to storage.
